(19) United States
(12) Patent Application Publication
(10) Pub. No.: US 2005/0059342 A1
(43) Pub. Date: Mar. 17, 2005

(54) Wireless cellular network architecture

(76) Inventors: Marc Engels, Wijgmaal (BE); Jan Erreygers, Tielt-Winge (BE); Frank Op't Eynde, Wilsele (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/884,802

(22) Filed: Jul. 1, 2004

Related U.S. Application Data
(63) Continuation of application No. PCT/BE03/00003, filed on Jan. 6, 2003.

(30) Foreign Application Priority Data
Jan. 7, 2002 (GB) 0200237.6

(51) Int. Cl. H04B 3/36

(52) U.S. Cl. 455/7; 455/11.1

(57) ABSTRACT

A system for cellular wireless communication is described comprising a repeater having one or more directional antennas. Signal communication can be made between one directional antenna of the repeater and a base station. Signal communication can be made between the same one directional antenna of the repeater with at least one remote terminal. Another system for wireless communication is disclosed. The system comprises at least one repeater having at least one transmitter and at least one receiver, wherein the at least one repeater is adapted to substantially simultaneously communicate signals with each of a plurality of remote terminals using a same frequency.

### RELATED APPLICATIONS

This application is a continuation application, and claims the benefit under 35 U.S.C. §§ 120 and 365 of PCT Application No. PCT/BE03/00003, filed on Jan. 6, 2003 and published Jul. 17, 2003, in English, which is hereby incorporated by reference.

### BACKGROUND OF INVENTION

1. Filed of the Invention

The present invention is related to wireless communications networks with centralised point of control such as a base station. Examples of such networks are cellular mobile wireless networks such as Global System for Mobile Communications (GSM), Universal Mobile Telecommunication System (UMTS), Advanced Mobile Phone Service (AMPS), etc. and Broadband Fixed Wireless Access Point-to-Multipoint networks. Also some Wireless LAN networks have a centralized point of control.

2. Description of the Related Technology

A wireless cellular network is characterized by the existence of remote terminals and one or more base stations, as depicted in FIG. 1. Each base station (1) covers a certain geographical region (the regions covered by different base stations can overlap). The remote terminals (2) communicate with the base stations (1). The base stations (1) act as relays, directing the information from/to the remote terminals (2) either to/from other remote terminals (2) or to/from a backhaul network, connected e.g., to the PSTN network or to the Internet network. Also, the wireless network organization and the access control are managed by the base stations or by management nodes that control several base stations.

The amount of information traffic at the base stations (1) is usually larger than the traffic at each remote terminal (2). In general, the base stations (1) are far more complex and expensive than the remote terminals (2). This is mainly due to the additional hardware and software, needed for the network management and for the connection to the backhaul network. Also, the quality/reliability of the radio equipment is higher, because of the larger amounts of information to be communicated. Furthermore, the base stations contain in general some redundant equipment, in order to be robust against technical failures.

Accordingly, the base stations (1) represent a considerable amount of the cost of a wireless cellular network. This is an up-front cost, to be invested before the network can be operational. Obviously, there is an economical interest in reducing the number of base stations (1), and hence in increasing the geographical coverage of each base station.

The maximum distance between a remote terminal and a base station is determined by the amount of radio signal attenuation that can be tolerated between the remote terminal antenna and the base station antenna. This signal attenuation can be derived from the following Equations 1 and 2:

$$\begin{matrix}R \leq BW \cdot {log}_{2} ( 1 + \frac{Received\_Signal \_Power}{Received\_Noise \_Power} ) & EQ . 1 \\ R \leq BW \cdot {log}_{2} ( 1 + \frac{Transmitted\_Signal \_Power / Attenuation}{Received\_Noise \_Power} ) & EQ . 2\end{matrix}$$

where R is the communication channel capacity (expressed in “bit/sec”) and BW is the radio signal bandwidth.

As can be seen, with all other parameters constant, the capacity of the communication link (R) is a function of the signal attenuation, and hence of the distance between the two communicating antennas. In order to guarantee a minimum capacity, this distance has to be limited.

### SUMMARY OF CERTAIN INVENTIVE ASPECTS OF THE INVENTION

One aspect of the present invention provides a cellular wireless network, comprising remote terminals, one or more base stations, and one or more repeaters. Each base station can communicate with some or all of the remote terminals, either directly or via the repeaters. The network can allow for the fact that the remote terminals cannot communicate with each other, and that repeaters cannot communicate with each other.

Another aspect of the present invention provides a system for cellular wireless communication comprising a repeater having one or more directional antennas, wherein the system is adapted for signal communication between one directional antenna of the repeater with a base station; and signal communication between the same one directional antenna of the repeater with at least one remote terminal. The one or more directional antennas may have an azimuth 3 dB beamwidth smaller than or equal to 120 degrees or smaller than or equal to 90 degrees, for example. The repeater may have at least a first and a second radio, wherein the first radio transmits via at least one of the directional antennas and the second radio transmits via another one of the directional antennas. Communications between the base station and repeaters, between the repeaters and the remote terminals, and between the base station and the remote terminals may make use of the same radio frequency band or frequency bands. Different communications may be separated from each other by a multiplexer in the Time-domain (TDM).

Another aspect of the present invention provides a system for wireless communication, whereby each communication is carried out between a transmitter and a receiver, the system comprising: a base station having at least one transmitter and at least one receiver; at least one repeater having at least one transmitter and at least one receiver; and at least two remote terminals each having an antenna with a front-to-back isolation of at least 15 dB and each having a transmitter and a receiver; means for obtaining information as to whether the antenna of each of the remote terminals is oriented towards or away from the base station; the system being adapted for simultaneous transmissions by selecting transmitters and receivers dependent upon the orientations of the antennas of the at least two remote terminals to thereby control co-channel interference between the simultaneous communications.

Several communications can occur simultaneously, for example, by provision of an intelligent scheduling in the time domain to thereby limit interference. Scheduling the transmission from the base station of data packets may be done in frames to repeaters and the sequence of transmitting data packets within a frame ordered according to a decreasing amount of time that is required by the repeaters to transmit data packets of the frame towards remote terminals in a direction towards the base station.

Means for using multiple antennas to set up parallel simultaneous communications at the same frequency between the base station and a plurality of repeaters or remote terminals may also be provided. The multiple antennas may be on the base station. One aspect of the present invention uses Multi-Antenna Techniques to provide simultaneous transmissions while reducing interference between the simultaneous transmissions.

The repeaters may be equipped with electronically-adjustable directive antennas. Several communications between repeaters and a base station can occur simultaneously and multiple-antenna techniques such as “Space-Time multiplexing” or “SDMA” are used to separate these communications. Some remote terminals may be able communicate with at least two repeaters. A database of the different possible and allowable connections may be maintained, in such a way that the network can switch instantaneously to an alternative connection. The information to be transmitted may be first transmitted to several repeaters, and these repeaters then re-transmit this information simultaneously. Some or all of these re-transmissions may be synchronized in such a way that the radio signals arrive substantially in-phase at the receiving antenna. Network management and scheduling of the different communications may be substantially performed centrally by a base station, i.e., with limited intelligence in the repeaters. Some or all of the remote terminals may be mounted outside buildings, e.g., below the roof. Alternatively, some or all of the remote terminals may be mounted in-door. Some or all of the repeaters may be mounted at a height that is below half of the height of the corresponding base station. For example, some or all of the repeaters may be mounted on the poles of the public street lightning or other public services. The power supply for the repeaters may be obtained directly from the public electricity network (i.e. from electrical energy that is not counted by an end-user's electricity meter).

The repeaters may be equipped with a number of directive antennas, wherein a selection device is used to select the signal from one of these directive antennas. Optimised radio connections and/or the existence of repeaters and/or remote terminals may be detected by means of a search mechanism (sometimes called “polling mechanism”).

The radio signals may be modulated with “Orthogonal Frequency Division Modulation”, “Single-Carrier modulation with cyclic prefix” or similar.

### BRIEF DESCRIPTION OF THE DRAWINGS

FIG. 1 shows a cellular Wireless Communications Network.

FIG. 2 shows a radio communications link with a repeater, the link consisting of two hops.

FIG. 3 shows a cellular wireless network with repeaters, only the coverage region of one base station is shown.

FIG. 4 shows several radio communications occurring simultaneously within the coverage region of one base station.

FIG. 5 shows an antenna, consisting of n (here: 25) directive antenna elements. With a selection device, one antenna element can be selected.

FIG. 6 shows a topology for simultaneous transmissions.

FIG. 7 shows another topology for simultaneous transmissions.

FIG. 8 shows a repeater with two radios for use with one embodiment of the present invention.

FIG. 9 shows a further topology for simultaneous transmissions.

FIG. 10 shows a Base Station sector and Repeaters network layout in accordance with an embodiment of the present invention.

FIG. 11 shows frame structures for simultaneous transmission in accordance with an embodiment of the present invention.

FIG. 12 shows redundancy by increasing the density of the repeaters.

FIG. 13 shows a base station with four sectors, only the repeaters in one sector are shown.

FIG. 14 shows a scheduling algorithm in accordance with an embodiment of the present invention.

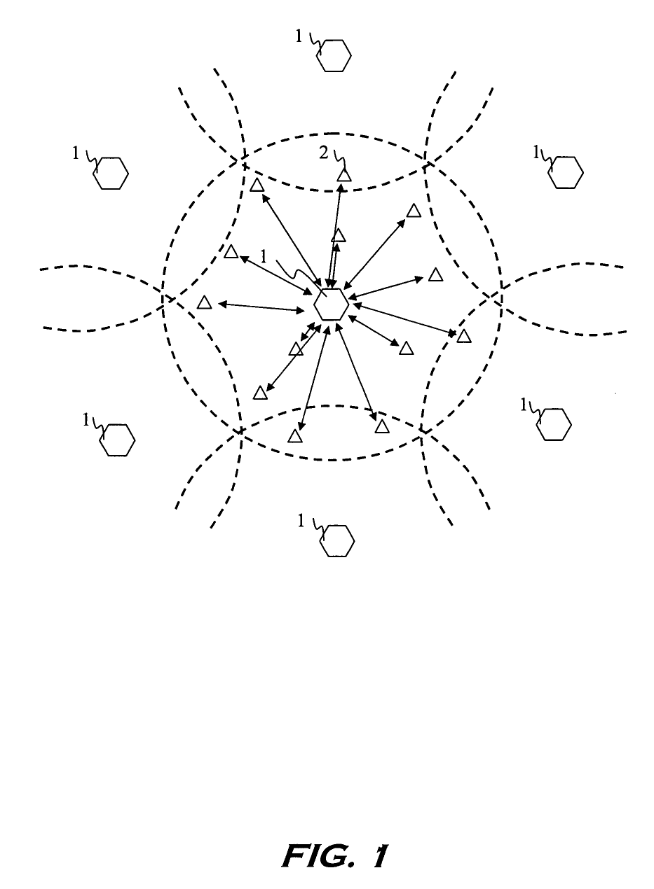

### DETAILED DESCRIPTION OF CERTAIN EMBODIMENTS OF THE INVENTION

Definitions

The following definitions may be useful in reading the specification but shall not be limiting or exclusive.

Wireless Cellular network: comprises a number of one or more discrete radio coverage areas each of which has a centralized point of control. This point of control is usually a base station.

Antenna gain: G generally refers to the power gain which the ratio of the radiation intensity of an antenna compared with that of an isotropic antenna. Manufacturers usually refer to a single value of G which is then the maximum value. The gain is the product to the directivity and the efficiency.

Directional antenna has antenna gain in the azimuth plane, i.e. there is one or more gain maxima in one or more directions in the azimuth plane. The 3 dB beam width in the azimuth plane is less than 180°.

Variable direction antenna is an antenna in which the direction of maximum gain can be changed during operation. An adaptive antenna is a form of variable direction antenna.

For further details on antennas for wireless communications reference is made to “Antennas and Propagation for wireless communication systems”, S. R. Saunders, Wiley, 1999. For further details on methods of operating cellular wireless systems and the use of repeaters to extend wireless networks, reference is made to “The Cellular Radio Handbook”, third edition, N.J. Boucher, Quantum Publishing, 1995, especially, chapters 10, 11 and 12. Various embodiments of the present invention are described with reference to drawings but these are provided only by way of example. The present invention may find wide application in wireless telecommunications networks as indicated by the attached claims. In particular, where reference is made to a remote terminal this may be a mobile terminal, e.g., a mobile phone unit or a fixed terminal, e.g., a desktop computer or a movable terminal, e.g., a laptop computer.

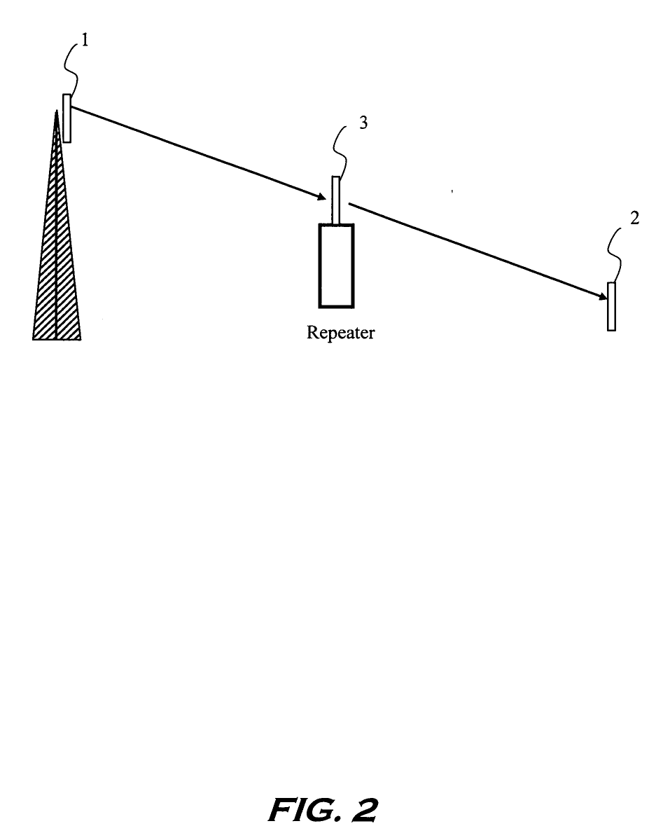

One aspect of the present invention is related to overcoming the distance limitation of wireless communications. A known solution to this problem is power control, e.g., in short distance links. In such a system, the power of each transmission is adapted to provide a minimum level of service. This known system has the disadvantage that high power transmissions may interfere with other users. Another known solution to this problem, e.g., for long-distance point-to-point microwave radio links, is the insertion of a repeater in the radio link, as depicted in FIG. 2: the information is first transmitted from the base station (1) to the repeater (3). In a second step, the repeater (3) amplifies the received signal and re-transmits it to the remote terminal (2). The resulting capacity of the link is then given by Equation 3:

$$R \leq BW \cdot {log}_{2} ( 1 + \frac{\begin{matrix}Transmitted\_Signal \_Power * gain / \\ Attenuation1 * Attenuation2\end{matrix}}{\begin{matrix}Received\_Noise \_Power1 * gain + \\ Received\_Noise \_Power2\end{matrix}} ) \qquad EQ . 3$$

Where gain is the repeater signal gain, and Attenuation1 and Attenuation 2 are the signal attenuations in the two radio links as shown in FIG. 2.

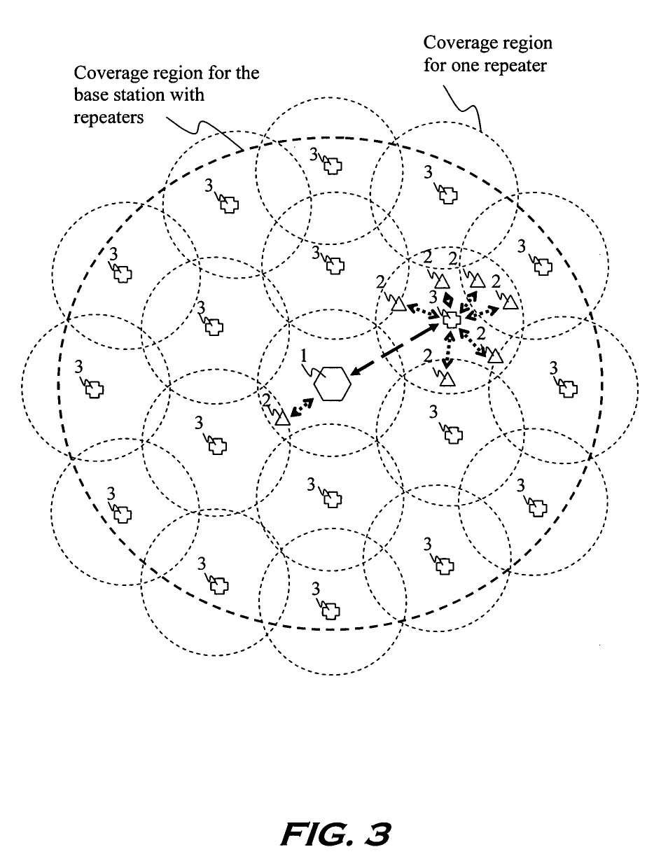

The goal of the repeater (3) is to satisfy equation 3 for those cases where a direct communication from the base station (1) to the remote terminal (2) would suffer from too large a signal attenuation. As a result, the total distance can be longer than the maximum distance achievable with a direct communication. Hence, less base stations are needed to cover a given geographical area. This leads to a cellular multi-hop network organization, as shown in FIG. 3: remote terminals (2) communicate either directly with a base station (1), or with a repeater (3). Repeaters (3) communicate with a base station (1) and with remote terminals (2). The principle of FIG. 2 can be extended to connections with more than two hops. A potential problem can occur with repeaters that generate a delayed and amplified version of the original signal. This signal might interfere with the original signal, causing fading and inter-symbol interference.

There are different types of repeaters. Traditional signal repeaters as discussed in the previous paragraphs, perform pure amplification of the received signal without any signal treatment. Another type of repeaters performs signal reception, demodulation, remodulation and retransmission. This type of repeater is sometimes also called regenerators. For this type of repeaters the attenuation of the link is determined by Equation 4:

$$R \leq BW \cdot min \{ \begin{matrix}{log}_{2} ( 1 + \frac{Transmitted\_Signal \_Power \_ 1 / Attenuation\_ 1}{Received\_Noise \_Power \_ 1} ) \\ {log}_{2} ( 1 + \frac{Transmitted\_Signal \_Power \_ 2 / Attenuation\_ 2}{Received\_Noise \_Power \_ 2} )\end{matrix} \} \qquad EQ . 4$$

A subclass of this type of repeaters consists of repeaters that perform demodulation, data interpretation and retransmission of only part of the received data.

In wireless networks for point-to-multipoint communication systems, it is important to distinguish the different communication paths and the different ways of multiplexing data transmission. Firstly, there is communication downlink from a base station to remote terminals and/or repeaters, and uplink from remote terminals and/or repeaters towards the base station. When a certain amount of spectrum is available, the downlink (DL) and uplink (UL) data can be multiplexed in several ways:
1. Frequency Division Duplexing (FDD): a different frequency is used for DL and UL. Typically the available bandwidth will be split in two bands: one for DL transmission and one for UL transmission.
2. Time Division Duplexing (TDD): a frequency or the whole of a frequency band is used for DL and UL data transmission. The DL and UL data transmission are scheduled at different times so that they do not interfere.

A second aspect of wireless point-to-multipoint systems is how the base station and the different remote terminals (RT) and/or repeaters (RP) are multiplexing their uplink and downlink communications without interfering with each other. Several ways of multiplexing are being used:
1. Frequency Division Multiple Access (FDMA): a number of communications between the BS and RTs/RPS are occurring simultaneously at different frequencies or are using different hopping patterns at the same frequencies. This leads to a number of parallel communications each with a lower data rate compared to using the full bandwidth reserved for UL data. Recently with the growing interest in OFDM, a particular FDMA technique, namely OFDMA was proposed.
2. Time Division Multiple Access (TDMA). The data transmission by the BS and the different RTs and/or RPs is scheduled at different times so that they do not interfere.
3. Code Division Multiple Access (CDMA): the data transmissions by the different RTs and/or RPs are done in the same frequency band, using different orthogonal codes. The codes may be imposed on the transmitted signal in various ways but the most common in civilian usage are direct sequence spread spectrum techniques.

In practical systems, the multiple access techniques can be combined. The GSM system, for instance, applies a combined FDMA/TDMA technique. Various embodiments of the present invention can be applied to any such access technique, e.g., CDMA, FDMA, TDMA, CDMA-FDMA-TDMA, FDMA-TDMA, CDMA-FDMA, etc.

In a point-to-multipoint wireless system that is using repeaters, there are also different possibilities for the multiplexing of the data transmission between the base station and the repeaters on one hand and the data transmission between the repeaters and the remote terminals on the other hand.
1. Frequency Division Duplexing Repeaters (FDD-R): one frequency or frequencies is used for traffic between the base station (BS) and the repeater (RP) on one hand and another frequency or frequencies for data transmission between the RPs and the RTs on the other. Typically the available bandwidth will be split into two or more bands which reduces the transmission capacity of the BS, when the amount of available spectrum is limited (which is the normal case).
2. Time Division Duplexing Repeaters (TDD-R): the whole frequency band is used for data transmission by the BS and RPs. The BS-RP traffic and the RP-RT traffic are scheduled at different times so that they do not interfere. As a consequence the capacity of the link is halved, because the Base Station can not transmit during a portion of the time. For example, communication in one direction can be within one half of a time slot, or within one half of a frame or only alternate frames. This means a reduction in capacity of about 50%.

For frequency division multiplexing schemes, a further distinction can be made between full duplex and half duplex elements. Full duplex elements, e.g., an FDD base station, can transmit and receive simultaneously on the DL and UL frequencies. A selection of different multiplexing types are summarized in table 1.

TABLE 1

| | | DL/UL multiple | |
|---|---|---|---|
| | Downlink-Uplink | access | BS-Repeater |
| Frequency | FDD | FDMA | FDD-R |
| full-duplex | FDD-FD | | FDD-R-FD |
| half duplex | FDD-HD | | FDD-R-HD |
| Time | TDD | TDMA | TDD-R |
| Code | | CDMA | |

The different multiplexing types can be combined in one system, e.g., FDD for DL-UL multiplexing, TDMA for UL multiple access and TDD-R for BS-repeater traffic mulitplexing.

Time-Multiplexed Repeaters

One aspect the present invention relates to systems that are using the TDD-R method for multiplexing the data transmission between the BS and RPs and the data transmission between RPs and RTs.

In general a TDD-R repeater uses one time period, e.g., one time slot to communicate with the base station, and another time period, e.g., a different time slot to communicate with a remote terminal. As a consequence, the capacity of the point-to-mulitpoint system is halved because the BS can transmit only half the time. In one embodiment, repeaters operate in asymmetric mode, that is that more transmissions in one direction are possible than in another. This may be useful when the traffic load is asymmetric, e.g., when the remote terminals are mainly browsing the Internet in which case the amount of traffic from the remote terminal to the repeater is much less (typically one tenth) of the traffic load from the repeater to the remote terminal (and from the base station to the repeater). The FDD-R and CDD-R approaches to multiplexing have the same drawback because transmission resources such as frequency spectrum or codes are allocated and hence the amount of bandwidth available for the base station is reduced.

Point-to-Multipoint systems combining TDD, TDMA and FDD-R are already known, e.g., as described in reference [1]. In this system the base station is polling every remote subscriber station and repeater sequentially. When a repeater has been polled, it starts polling the remote subscriber stations that are communicating with it, using a different frequency. This scheduling scheme works for low density, low traffic applications. When the number of user terminals increases and the traffic load becomes more important, this type of scheduling of transmissions is inefficient. In broadband wireless access applications, typically only 10-50% of the user terminals will be active simultaneously. Therefore, it is a waste of bandwidth to continuously poll all the user terminals and repeaters.

Repeaters Using the Same Directional Antenna for Communication with the Base Station and Remote Terminals

A typical repeater unit has a highly directional antenna for communication with the Base Station and an omnidirectional antenna for communication with user terminals that cannot communicate directly with the Base Station. This concept of repeater antennas has several drawbacks:
1. Two different antennas need to be installed, which makes the installation more complicated, expensive and less aesthetically pleasing. A highly directional antenna requires precise orientation towards the Base Station (BS). If this requires site visits the cost of installation is increased.
2. The use of an omnidirectional antenna for communication with the Remote Terminals (RT) limits the maximum distance of transmission. Omnidirectional antennas have little antenna gain and are susceptible to interference coming from all directions. Sometimes the omnidirectional antenna is replaced with a sectorized antenna, comprising a number of sectors, in order to increase the range between the repeater and the remote terminals. The directivity of the sectorized antenna is significantly less than the directivity of the antenna for communication with the base station.

Repeaters using one omnidirectional antenna for both communication with the BS and the RTs do exist. However, they are limited in maximum transmission distance towards the BS and also towards the RTs. They also are very sensitive to interference.

An aspect of the present invention is to use the same directional antenna or antenna element, in case of sectorized antennas, for communication with the BS and for communication with the RTs. The use of the same antenna or antenna element is not obvious. At first sight one would consider the loss of directivity for the communication with the BS. However, in Non-Line-of-Sight transmission conditions, the antenna cannot be too directional because otherwise too much multipath radiation is lost. The loss of directivity is more than compensated by:
1. Reduction of the cost of the equipment because one antenna is eliminated
2. Reduction of the cost of installation. Because the antenna is less directional it does not need to be pointed towards the BS as accurate as with a highly directional antenna.
3. Almost automatic inclusion of redundancy in connection with the BS. The repeater generally has a sectorized antenna, e.g., 6 antenna elements each with 60 degree 3 dB beam width. The repeater can be designed so that the communication with the BS can be done using any of these antenna elements. This permits communication with different base stations in different directions, so redundant communication paths can be set up without the need for extra antennas.
   Time Multiplexed Repeaters with Electronically Adjusted Antennas

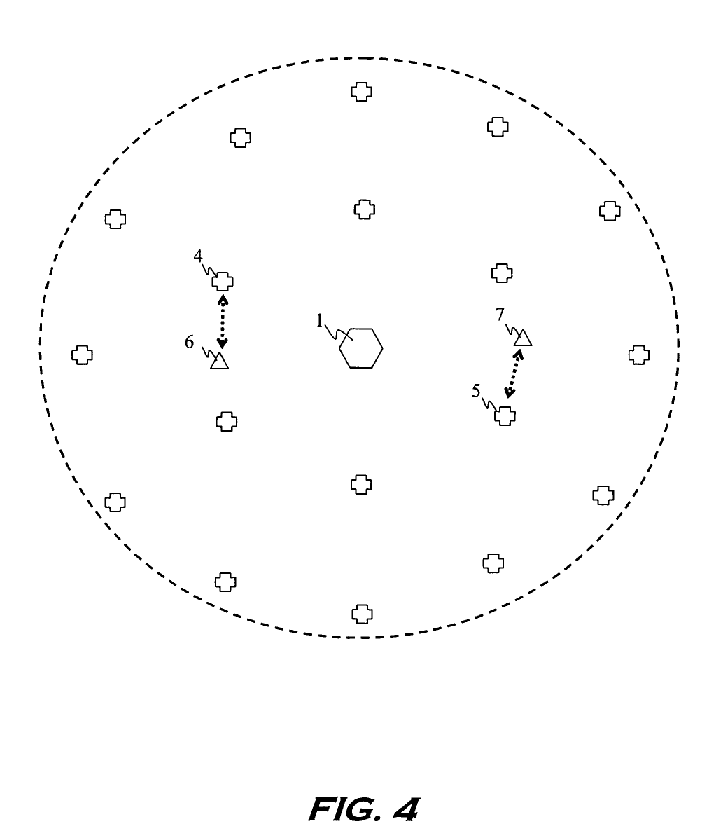

Another aspect of the invention reduces the interference between simultaneous transmissions by using repeaters with adjustable selective antennas that can be, for example, electronically or mechanically pointed towards the different remote terminals. An example is shown in FIG. 4. When time-multiplexed repeaters (4) and (5) are equipped with directive antennas pointing towards remote terminals (6) and (7) respectively, the interference between the two communications will be eliminated almost completely.

In one embodiment of this aspect of the invention, the antenna consists of N fixed directive beams. The direction of the antenna is electronically adjusted by selecting one of these beams by means of a selection device.

A potential problem with directive antennas on the time-multiplexed repeaters is the access protocol. Indeed, when a remote terminal wants to start the communication, the time-multiplexed repeater does not know where to point its antenna. Two possible solutions exist: (a) using an omnidirectional antenna for certain signalling activities, e.g., during the random access phase. This, however, will be the limiting factor for the communication distance between the time-multiplexed repeater and the remote terminal; (b) using an antenna with a limited number of fixed beams during the random access phase. For each beam a random access time slot must be foreseen. The remote terminal then tries to access the time-multiplexed repeater during each of these time slots.

In one embodiment, the repeater concept with a single antenna pursues the cost-optimization of the repeaters and the network. Indeed, the whole time-multiplexed repeater concept relies on the fact that a repeater is substantially less expensive than a base station.

Since a repeater covers a smaller geographical region than a base station (see FIG. 3), it can be placed at a considerably lower height (e.g., below half of the height of a base station). The repeater can be mounted cheaply, e.g., on poles of the public street lightning. The power supply for the repeater can be obtained directly from the public electricity network (i.e. not from a private electricity account).

Similarly, remote stations can be mounted below the roof, or in-house. In order to reduce the amount of hardware and software included in the repeater, the repeater functionality can be substantially limited to the functionality of a selective signal relay: all network management and access scheduling is organized centrally by the base station, and not by the repeaters.

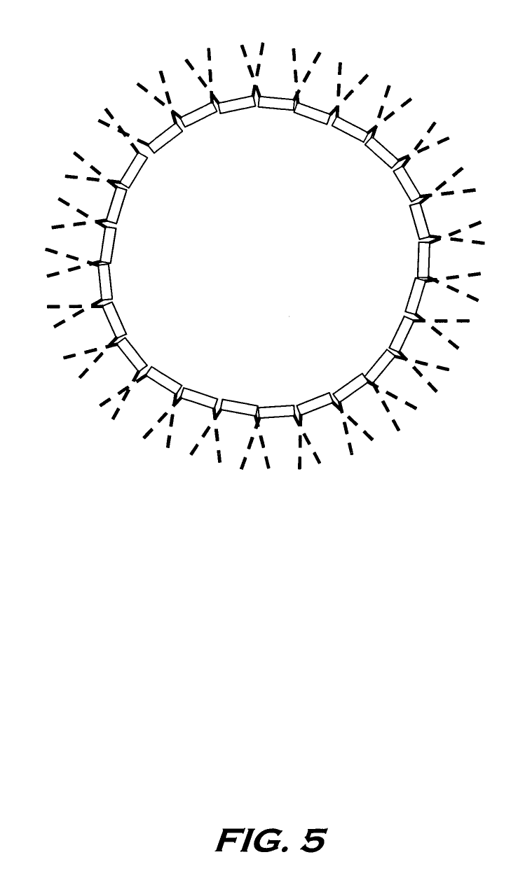

The repeaters can be equipped with a directive antenna, as shown in FIG. 5. This antenna consists of n directive antenna elements, pointing in different directions. The antenna direction can be changed by selecting one of these elements, by means of a selection device. These antenna elements can be substantially flat, such as a patch antenna. By means of a search mechanism (sometimes called “polling mechanism”, “scanning mechanism” or “inquiry mechanism”), the network can automatically detect the existence of new remote stations or repeaters, can detect technical failures, and can configure the optimum radio connections and access sequences.

Simultaneous Communications from and to One Repeater

In Broadband Fixed Wireless Access Systems (BFWA), one typically assigns one broadband channel to one radio cell or to a sector of a cell. When a repeater, as described above, is used, the repeater can communicate either with the BS or with an RT. The use of the scarce spectrum would become more efficient if the Repeater could communicate simultaneously with more than one RT. This leads to another aspect of the present invention: simultaneous communication between the RP and multiple RTs using the same frequency. The case for simultaneous communication with 2 RTs will be described. In one embodiment, the repeater is equipped with two radios: Ra1 (20) & Ra2 (22). Each radio is connected to an antenna that covers a certain angle, e.g., an angle of 180° or less, using one antenna or a sectorized antenna. For example, a smart directional antenna can be used that is divided it in two separate parts as shown in FIG. 8. The number of antenna elements has been limited to simplify the drawing.

Each radio feeds one part or 3 directional elements of the antenna. When the antenna elements are sufficiently directional, e.g., 20-30 dB front-to-back isolation, the two radios (20, 22) can transmit or receive simultaneously. In general, it may not be possible for the radios (20, 22) to transmit or receive simultaneously in two adjacent sectors on the same frequency because of co-channel interference. In the case of FIG. 8, this means that sectors 1 and 6 may not be served simultaneously, as well as sectors 3 and 4. This issue does not arise for sectors 1, 2, 3 e.g., because they are connected to the same radio (20 or 22).

In TDD mode (Time Division Duplexing) it may not be possible that one of the radios is receiving while the other is transmitting because of too strong co-channel or even adjacent channel interference. Even if the two radios (20, 22) were transmitting on different frequencies, the crosstalk will probably be too large. However, the two radios (20, 22) can transmit simultaneously and receive simultaneously.

Scheduling General Considerations

In Point-to-Multipoint (PMP) cellular systems, either the network planning defines which frequencies are to be used in the different cells or the different cells may determine their own frequencies adaptively by listening to adjacent cells and selecting frequencies which reduce interference. In the case of FDD and FDD-R systems, the network planning can also determine which frequencies are assigned for uplink/downlink transmission and BS-RP and RP-RT transmission. In TDD and TDD-R systems, the different elements are assigned different time periods, e.g., time slots, for transmission. This is called the scheduling of the transmission periods, e.g., slots. This scheduling can be fixed in time, i.e. the same time period, e.g., time slot in a frame, is always assigned to a particular network element. In general the scheduling is dynamic and changes over time. In the rest of this application the term scheduling refers to dynamic assignment of transmission time periods, e.g., time slots, to BS, RPs, RTs.

The base station or another network-side network element such as a base station controller controls the schedule (e.g., TDD, TDMA & TDD-R) and also assigns the time periods, e.g., time slots. The base station then broadcasts the schedule to the remote terminals and to the time-multiplexed repeaters. Next, the time-multiplexed repeaters broadcast this schedule or a part of this schedule to the remote terminals that cannot communicate directly with the base station. In a further optimization to reduce the protocol overhead, the schedule is split in two parts. The first part is only intended for the repeaters and RTs communicating directly with the BS, and it is not further broadcasted to the remote terminals. The second part contains information on the communication time periods, e.g., time slots, between the repeaters and the remote terminals and is broadcast to the RTs.

In the TDMA schedule, for example, time periods, e.g., time slots, for random access are foreseen such that remote terminals can indicate to the base station that they want to start communicating. The remote terminals that cannot reach the base station directly, use the random access time period, e.g., time slot, to signal the time-multiplexed repeater. Next, the repeaters transfer the access requests of the remote terminals to the base station. The base station or another network-side network element acknowledges the remote terminal access requests as part of the TDMA schedule broadcast.

Although time-multiplexed repeaters allow extending the communication range of a base station without the need for extra spectrum, they obviously reduce the total capacity of the cell, because each communication requires two time slots. Another problem is the decreasing robustness of the network. Indeed, base stations are normally equipped with redundant hardware and software, but the repeaters will not be. As a remote terminal will preferably communicate with only one repeater, major parts of the network have no backup in case of technical failure or obstruction of a radio transmission path. The principle of time-multiplexed repeaters can be extended to more than two hops.

Multiple Simultaneous Transmissions

In wireless communications, the scarce resource is often the spectrum that is available. When TDMA, FDMA or CDMA multiple access systems are used, it is not possible to reuse the same frequency band or the same orthogonal codes in the same or adjacent sectors. The reason is that co-channel interference would make the Carrier-to-Interference & Noise Ratio (CINR) too low. A lot of effort is spent in radio network planning to optimize the reuse of channel frequencies.

Optimization of the use of the limited spectrum can be achieved by allowing several communications between repeaters and remote stations and/or repeaters to base stations to take place in the same time period, e.g., in the same time slot, on the same frequency or using the same orthogonal code. Although multiple communications are taking place in the same time period, e.g., time slot, each repeater radio or remote station is involved in only one communication in a single time period, e.g., time slot. The base station will assign the communications that are jointly using a time period, e.g., time slot and broadcast this information in the schedule. A potential problem in such communication is the mutual interference between these communications.

One aspect of the present invention is to improve this approach with an intelligent scheduling in the base station of all ongoing communications, in such a way that mutually interfering communications are scheduled during different time periods, e.g., time slots.

In one embodiment, multiple simultaneous transmissions are performed by the use of directional antennas in the repeaters and remote stations. In one embodiment, a sufficient front-to-back attenuation of the antenna is provided when it has been installed at the customer premises. Signals that are arriving from the back or from the side have to be attenuated sufficiently in order to allow the demodulation of the intended. These unwanted signals may not cause the signal-to-interference ratio to be lower than the values in table 2:

TABLE 2

| Modulation | Minimum CINR |
|---|---|
| QPSK ½ | 8 dB |
| QPSK ¾ | 11 dB |
| QAM-16½ | 15 dB |
| QAM-16¾ | 18 dB |
| QAM-64⅔ | 23 dB |
| QAM-64¾ | 25 dB |

In one embodiment, the minimum signal to noise requirements are increased by the implementation loss of the receivers in the RTs and RPs.

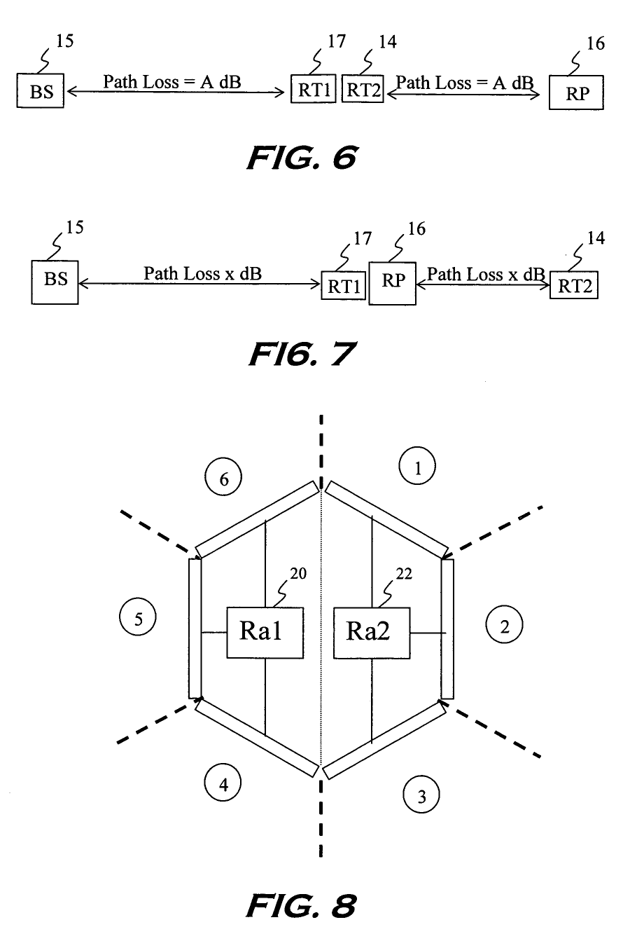

Examples of topology for simultaneous transmission are shown in FIGS. 6 and 7: RT1 (12) communicates with the BS (15), RT2 (14) communicates with the RP (16). Typically the BS (15) antenna will be at an elevation of 20-40 meters. The RP (16) antenna will be at an elevation of 10-20 meters. The remote terminals at the customer premise are typically installed at a height of 3-5 meters. Therefore, the distance between the BS (15) and RP (16) can be much greater than between the BS/RP and the RTs (17, 14). More information on path loss and signal attenuation can be found in [2]. An RT will communicate with the BS (15) if the path loss towards the BS (15) is smaller than the path loss towards the RP (16). In the situation as shown in FIG. 6, the path losses between RT1&2 (17, 14) and the BS (15) and RP (16), respectively are equal. Therefore, the CINRs for the signals received by RT1 (17) and RT2 (14), respectively are equal if the transmit powers of the BS (15) and RP (16) are equal. Assuming that the distance between the two RTs (17, 14) is small, the attenuation of the BS signal compared to the RP (16) signal for RT2 (14) will equal the front-to-back attenuation of the installed RT.

Assuming that the antennas have a front-to-back directivity of e.g., 20 dB, the following signals can be transmitted simultaneously:
UL from RT1 (17) to BS (15) with UL from RT2 (14) to RP (16)
DL from BS (15) to RT1 (17), with DL from RP (16) to RT2 (14)
   Scheduling for Simultaneous Transmissions from and to BS and RP

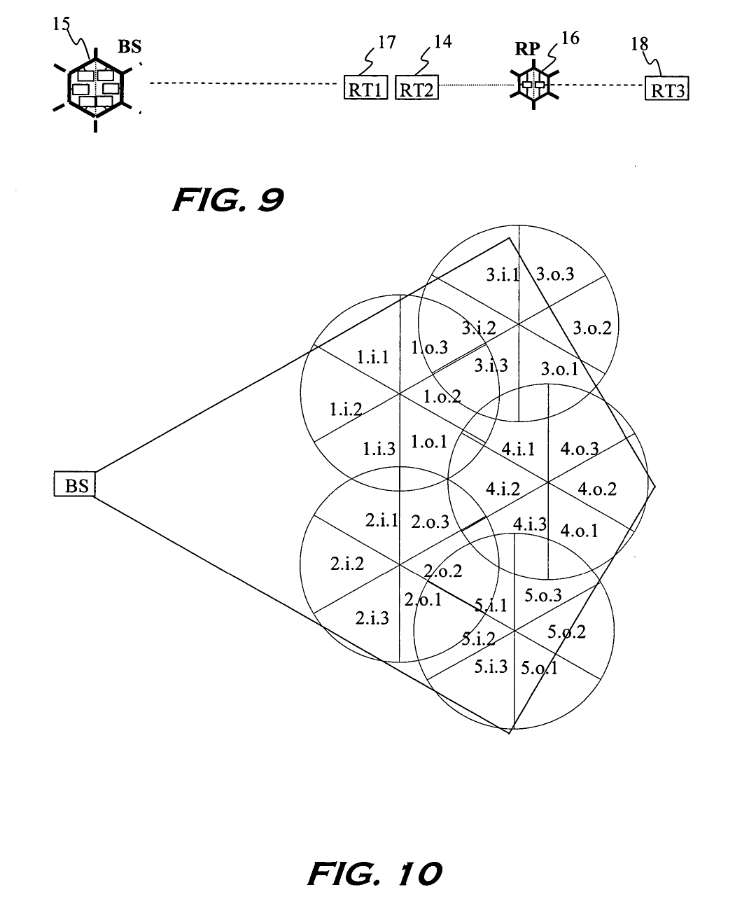

FIG. 9 shows a typical placement of BS (15), a RP (16) with two radios and several RTs (17, 14, 18). For all the antennas the front to back isolation is larger than e.g., 20 dB.

One embodiment of the invention is focused on the orientation of the sectors of the repeaters. Some sectors are oriented towards the BS (inward sectors) other sectors are oriented away from the BS (outward sectors).

The following transmissions can occur simultaneously:
BS (15) TX downlink to RT (17)& RP (16) TX downlink to RT2(14) (inward)
RP (16) TX downlink to RT2 (14) (inward) & RP (16) TX downlink to RT3 (18) (outward)
BS (15) TX downlink to RP (16) (inward) & RT3 (18) TX uplink to RP (16) (outward)
RP (16) TX uplink to BS (15) (inward) & RP (16) TX downlink to RT3 (18) (outward)
RT1 (17) TX uplink to BS (15)& RT2 (14) TX uplink to RP (16) (inward)
RT2 (14) TX uplink to RP (16) (inward) & RT3 (18) TX uplink to RP (16) (outward)

Because the BS (15) is at high elevation, the path loss between the BS (15) and RT3 (18) will not be much higher than the path loss between the RP (16) and RT3 (18). Therefore, in this embodiment, the following transmissions may not occur simultaneously because co-channel interference will be too high:
BS (15) TX downlink to RT1 (17)& RP (16) TX downlink to RT3 (18) (outward)
RT1 (17) TX uplink to BS (15)& RT3 (18) TX uplink to RP (16) (outward)

As it has been demonstrated that simultaneous transmissions are possible, the scheduling of the transmissions between the different elements of the system becomes important. The connection to the backbone network is made through the base station. Therefore, the data throughput in the cell or in a sector of cell is maximized when the radio of the base station is occupied as much as possible.

Optimal scheduling can be achieved with one repeater on the condition that at least half of the traffic is going to and coming from terminals that are communicating directly with the Base Station. The reason is that the RP cannot receive from the BS and transmit towards RTs simultaneously. So when the RP is transmitting towards RTs, the Base Station should transmit to RTs, or receive UL traffic from RTs or from the RP. When a cell or sector of a cell comprises two repeaters, very efficient scheduling can be achieved even when the traffic is going to only the two repeaters. The reason is that the RPs can combine DL traffic to the inward as well as to the outward sectors.

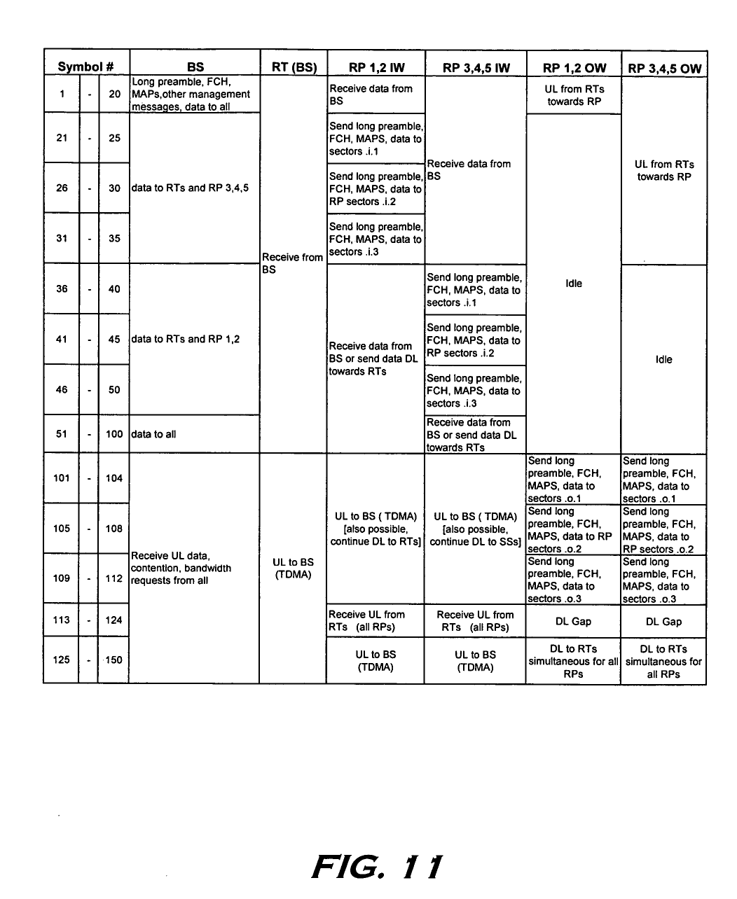

Typically in a sector of a cell, several repeaters are installed. FIG. 10 shows a typical layout of a 60° sector of a cell with 5 repeaters, however, one embodiment of invention includes the use of other sector angles. Each repeater covers an area with an azimuth of 360° that is again divided in 60° sectors. The identification of each sector of the repeaters is in the x.y.z format:
x=repeater number
y=i or o: i for inward oriented towards the base station, o for outward oriented away from the base station
z=sector number

In this more elaborate situation the transmissions of table 3 can be done simultaneously, all of which are separate embodiments of the present invention:

TABLE 3
Simultaneous transmissions in TDD-duplexing

| | BS UL | BS UL | RP | RP | RP | RP |
|---|---|---|---|---|---|---|
| | From | from | inward | inward | outward | outward |
| | RT | RP | DL | UL | DL | UL |
| BS DL | | | X | | | X |
| BS UL | | | | X | X | |
| from RT | | | | | | |
| BS UL | | | | X (other | X | |
| from RP | | | | RPs) | | |
| RP inward | | | | X (other | X | |
| sectors DL | | | | RPs) | | |
| RP inward | | | | | | X |
| sectors UL | | | | | | |
| RP outward | | | | | | X (other |
| sectors DL | | | | | | RPs) |
| RP outward | | | | | | |
| sectors UL | | | | | | |

The example of simultaneous transmissions shown above is the TDD-duplexing case wherein all transmissions use the same frequency. When FDD-duplexing is used for downlink-uplink duplexing, the downlink and uplink transmissions are using different frequencies. When the base station and the repeaters are capable of operating in full duplex mode, there is no interaction between the downlink and uplink transmissions and the downlink and uplink transmissions can occur simultaneously independently from each other.

It needs to be noted that care needs to be taken in the power control. For example, when uplink (UL) transmission occurs to both the inward and outward radio of a repeater, the received power levels have to be relatively close.

Also not all transmission opportunities can happen simultaneously. For example, DL from the BS can be combined with the DL from the RP inward. The DL from the BS can also be combined with the UL from the RP outward sectors. However, DL from the RP inward may not be combined with UL to the RP outward because the power levels of transmit and receive are too different.

FIG. 11 shows an example of scheduling for TDD for a network layout as shown in FIG. 10. The example assumes OFDM transmission as described in [3] and a TDD frame of 150 OFDM symbols. Remark that this concept of scheduling is in no way limited to OFDM transmission.

A frame starts with two OFDM preamble symbols, followed by downlink and uplink MAPs that describe the structure of the frame, and possibly followed by other management messages and data packets. In one embodiment, these messages are received by all RTs and RPs. The frame is divided in two parts: 100 symbols for DL transmission from the BS and 50 symbols for UL transmission towards the BS.

For RTs that are communicating with a RP, the RP is indistinguishable from a BS. Towards each sector of the RP a frame similar to the frame used by the BS is transmitted. Each sector receives it DL and UL MAPS. The transmission towards a sector does not need to be continuous. In the MAPs idle time can be defined.

In the following description all numbers are given as an example. Frame for BS:
Symbols 1-20: Transmission of OFDM preambles, DL/UL MAP message and data to RPs or RTs that communicate directly with the BS.
Symbols 21-35: Data are transmitted towards RPs 3,4,5 and RTs because the RPs 1 & 2 inward sectors are transmitting the start symbols of their frames.
Symbols 36-50: Data are transmitted towards RPs 1,2 and RTs because the RPs 3,4,5 inward sectors are transmitting the start symbols of their frames.
Symbols 45-100: Data are transmitted towards all RPs and RTs.
Symbols 101-150: Receive UL transmission from RTs and RPs
   Note: The BS will try to transmit first data towards RPs, so that the RPs can start as quickly as possible to transmit data DL towards their inward sectors.

RTs that communicate directly with the BS:
Symbols 1-100: Receive preambles, MAPs and data from the BS
Symbols 101-150: Send UL data towards the BS
   Repeaters 1 & 2 Inward Sectors:
Symbols 1-20: Reception of OFDM preambles, DL/UL MAP message and data from BS
Symbols 21-25: Transmission of OFDM preambles, DL/UL MAP messages and data to RTs that communicate with the RP sectors 1.i.1 & 2.i.1.
Symbols 26-30 Transmission of OFDM preambles, DL/UL MAP messages and data to RTs that communicate with the RP sectors 1.i.2 & 2.i.2.
Symbols 31-35: Transmission of OFDM preambles, DL/UL MAP messages and data to RTs that communicate with the RP sectors 1.i.3 & 2.i.3.
Symbols 36-100: First continue to receive data from the BS until the RP has received all its data. Then start transmitting data towards the RTs in the different inward sectors.
Symbols 101-115: The RPs can continue to transmit information DL to the inward sectors while the RPs transmit preambles and MAPs. The RP can also start to transmit UL towards the BS
Symbols 116-130: Receive UL transmission from RTs
Symbols 131-150: Transmit UL towards BS.

Repeaters 3,4,5 inward sectors:
Symbols 1-35: Reception of OFDM preambles, DL/UL MAP message and data from BS
Symbols 35-40: Transmission of OFDM preambles, DL/UL MAP messages and data to RTs that communicate with the RP sectors 3.i.1, 4.i.1 & 5.i.1.
Symbols 41-45 Transmission of OFDM preambles, DL/UL MAP messages and data to RTs that communicate with the RP sectors 3.i.2, 4.i.2 & 5.i.2.
Symbols 46-50: Transmission of OFDM preambles, DL/UL MAP messages and data to RTs that communicate with the RP sectors 3.i.3, 4.i.3 & 5.i.3.
Symbols 50-100: First continue to receive data from the BS until the RP has received all its data. Then start transmitting data towards the RTs in the different inward sectors.
Symbols 101-115: The RPs can continue to transmit information DL to the inward sectors while the RPs transmit preambles and MAPs. The RP can also start to transmit UL towards the BS
Symbols 116-130: Receive UL transmission from RTs
Symbols 131-150: Transmit UL towards BS.
   Repeaters 1 & 2 Outward Radios:
Symbols 1-20: Reception of UL data from RTs
Symbols 21-100: No transmission or reception Symbols 101-105: Transmission of OFDM preambles, DL/UL MAP messages and data to RTs that communicate with the RP sectors 1.o.1 & 2.o.1.
Symbols 106-110: Transmission of OFDM preambles, DL/UL MAP messages and data to RTs that communicate with the RP sectors 1.0.2 & 2.0.2.
Symbols 111-115: Transmission of OFDM preambles, DL/UL MAP messages and data to RTs that communicate with the RP sectors 1.0.3 & 2.0.3.
Symbols 116-130: No transmission. In principle UL transmission is possible if it is allowed that UL data can be transmitted before DL data in a frame.
Symbols 131-150: Transmit DL data towards RTs.
   Repeaters 3,4 & 5 Outward Radios:
Symbols 1-35: Reception of UL data from RTs
Symbols 36-100: No transmission or reception
Symbols 101-105: Transmission of OFDM preambles, DL/UL MAP messages and data to RTs that communicate with the RP sectors 3.0.1, 4.0.1 & 5.0.1.
Symbols 106-110: Transmission of OFDM preambles, DL/UL MAP messages and data to RTs that communicate with the RP sectors 3.0.2, 4.0.2 & 5.0.2.
Symbols 111-115: Transmission of OFDM preambles, DL/UL MAP messages and data to RTs that communicate with the RP sectors 3.0.3, 4.0.3 & 5.0.3.
Symbols 116-130: No transmission. In principle UL transmission is possible if it is allowed that UL data can be transmitted before DL data in a frame.
Symbols 131-150: Transmit DL data towards RTs.
   Intelligent Scheduling

The general procedure of scheduling in accordance with an embodiment of the present invention runs as follows: DL packets scheduling
A number of packets are received for DL transmission by the BS.
The packets are sorted according to priority.
If all packets can be transmitted in the frame, scheduling starts, otherwise it is estimated how many packets/bytes can be transmitted and the packets with the highest priority are taken.
The packets are sorted according to repeater and to repeater sector. The packets that are for RTs directly communicating with the BS are placed last in the queue.
Then it is calculated for each repeater how many OFDM symbols are required for transmission of the data packets towards the inward sectors and how many OFDM symbols are required for transmission towards the outward sectors. Note: this calculation is required because each data packet can be sent in a different modulation mode. Therefore, it is possible that a larger packet is transmitted using less OFDM symbols than a smaller packet.

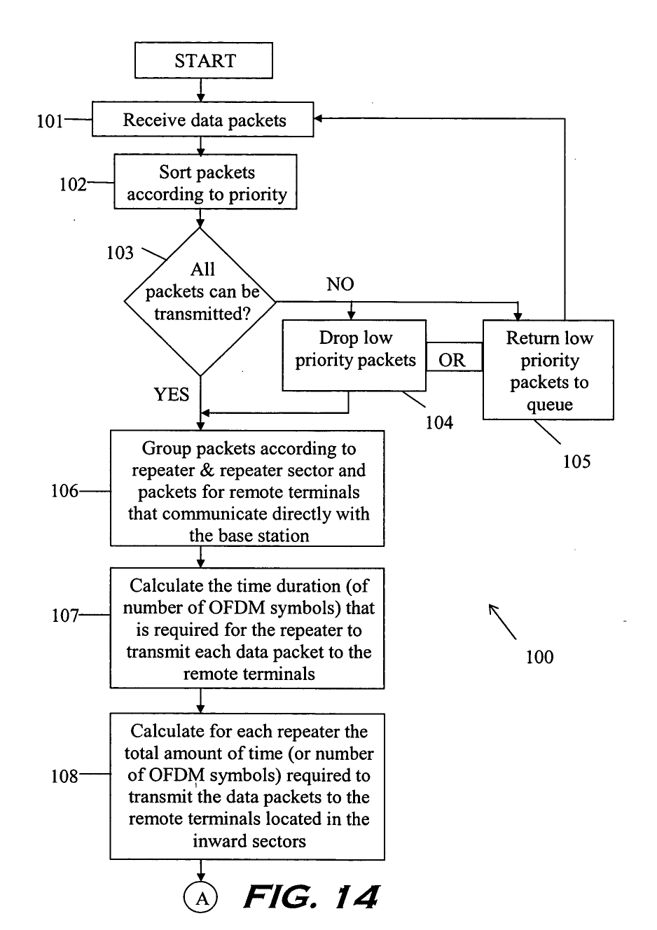

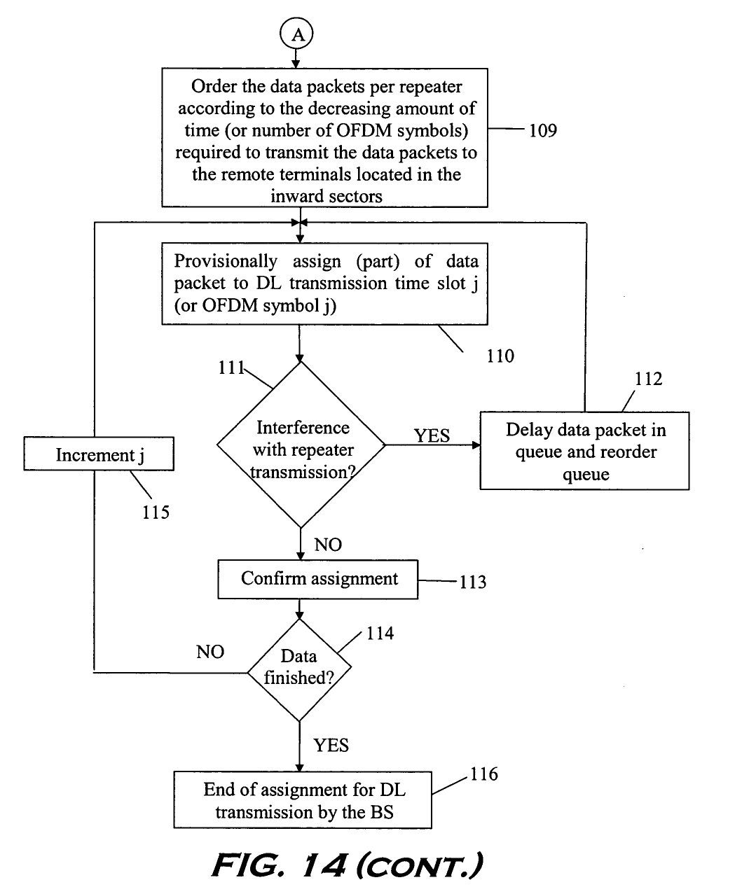

Then the packets are reordered per repeater according to the decreasing amount of OFDM symbols that are required for the transmission towards the inward sectors. The reason is that the repeater that has to transmit the most symbols to the inward sectors, should start transmitting first. As soon as this repeater has received its packets, it can start transmitting downlink towards the inward sectors because this can be done while the BS continues its DL transmission. Then the repeater with the second largest amount of DL OFDM symbols towards its inward sectors receives its data, and so on. A base station downlink assignment method 100 is shown in the flow diagram of FIG. 14. In step 101, the base station receives data packets to be transmitted to remote terminals. In step 102, these are sorted according to priority if prioritization of the data packets is an option of the system. In step 103, it is decided whether all the packets can be transmitted. If NO in step 103, low priority packets are dropped in step 104 or are returned for further processing in step 105. If YES in step 103, the packets are grouped in step 106 according to the repeater and repeater sector to be used for the transmission to the remote terminals as well as those which are to be communicated directly from the base station. In step 107, the amount of time required, or a representative value related to this time (e.g., the number of OFDM symbols), for the repeaters to transmit the data packets to the remote terminals is determined. In step 108, the total time, a representative value related to this time (e.g., the number of OFDM symbols), required to transmit to the remote terminals communicating with the inward facing antenna of each repeater is determined. In step 109, the data packets are ordered for transmission to the repeaters according to decreasing time (or change of the representative value thereof) require to transmit the data packets to the remote terminals communicating with the inward sectors of the repeater. In step 110, a part of the ordered data is assigned to a downlink timeslot j. In step 111, it is determined whether there will be interference if this data is now sent by the base station. If YES in step 111, the packet is delayed in step 112, and returned for further processing. If No in step 11, the assignment is confirmed in step 113. The data may then be transmitted by the base station. In step 114, it is determined if all data has been processed. If No in step 114, the value of j is incremented by one. If YES in step 114, the downlink assignment procedure is finished.
Then the packets are scheduled for DL transmission by the BS. In principle the packets are sent in the order in which they have been placed in the previous step. However, it is possible that a packet would be transmitted at a time of the frame when the repeater has to transmit preambles and other management data towards the inward sectors. This would prevent the RP from being able to receive the data packet. Therefore, if a packet for e.g., RP1 would be scheduled at a moment that RP1 is transmitting DL on its inward radio, the transmission of this packet is delayed and scheduled until this RP1 has finished transmitting its preambles and MAPs toward the inward sectors. In the mean time packets can be sent to other repeaters. For example, while RP1 and RP2 are transmitting towards their inward sectors, packets for RPs 3,4,5 can be scheduled. When the RPs 3,4,5 are transmitting towards their inward sectors, packets can be sent to RPs 1&2 or to RPs communicating directly with BS. To optimize the scheduling packets may be fragmented: i.e., a first fragment of the packet is transmitted until the RP starts to transmit. When the RP is again ready to receive, a second fragment is sent. When all the packets are sent towards the repeaters, the remaining packets are sent to the RPs that are communicating directly with the Base Station.
Then the transmission of the DL packets for the repeaters towards their inward sectors is scheduled. The DL transmission towards the inward sectors by each RP starts after the RP has received all his data. The RP has been informed about this in a private message. The DL transmission can continue up to the end of the preamble and MAP transmissions for the outward sectors.
The transmission of DL packets by the RPs to their outward sectors is scheduled at the end of the frame. All RPs can send packets to their outward sectors simultaneously.
In case the scheduling encounters a conflict, i.e., not all packets can be scheduled in the frame, several solutions can be applied:
   For example, the frame length can be adjusted on a per frame basis to accommodate all the packets.
   A packet with low priority can be put back in a queue and the schedule is being recalculated.
A further refinement is:
   1. When there is possibility of interference between transmissions in different repeater sectors, the scheduling algorithm can consult a database that contains the necessary information to decide if simultaneous transmission in the sectors is allowed. If simultaneous transmission is not allowed at that point in time, the transmission of the packet shall be delayed until later in the frame.
      UL Packet Scheduling
Scheduling of UL packets. In reality the BS does a scheduling based on bandwidth request from the RTs. The BS does not have to schedule all the bandwidth that is requested by an RT. Low priority traffic may be delayed. For convenience, the terminology UL packets will be used.
First the packets are ordered according to priority and it is estimated which packets can be transmitted during this frame.
UL packets to the RPs from the outward sectors can be transmitted at the beginning of the BS frame until the RPs start transmitting DL towards the inward sectors. These uplink packets can be transmitted towards the RPs simultaneously. Per RP, the packets are scheduled according to priority. Remaining time in the frame until the RP starts transmitting inwards, is reserved for contention.
When the RP outward radios are transmitting DL, the RPs can already transmit the UL packets that have been received from the outward sectors, towards the BS. In this time period also the RTs that communicate directly with the BS can transmit data UL. Scheduling is done according to priority of packets.
After the transmission of preambles and MAPs by the RP outward radios, a period is reserved during which the UL packets from RTs towards the RP inward radios can be scheduled. These packets can be sent simultaneously for the different RPs. In this time period also the RTs that communicate directly with the BS can transmit data UL because they are transmitting in the opposite direction. By reserving this time period after the transmission of the preambles, it makes is possible for the RPs to continue to send data DL to the inward sectors while the RP sends already preambles to the outward sectors.
At the end of the frame when the RP outward radios are transmitting DL, UL packets towards the BS from the RPs can be scheduled. In this time period also the RTs that communicate directly with the BS can transmit data UL.

The scheduling algorithm has been illustrated for Time Division Duplexing (TDD). The same principles can be applied for Frequency Division Duplexing (FDD). For FDD there is an additional possibility to improve the efficiency. When the downlink frequency for the communication between the repeater and the remote terminals in the outward sectors is the same as the uplink frequency towards the base station (Fu), then the repeater can transmit simultaneously downlink towards the inward sectors, using the downlink frequency from the base station (Fd), and downlink towards the outward sectors, using the uplink frequency towards the base station (Fu). At the same time the base station can continue to transmit downlink (Fd) because this transmission will not interfere with the downlink transmission from the repeater towards the outward sectors (Fu). In the same way uplink transmissions can be combined. Uplink transmission from the outwards sectors towards the repeaters using the downlink transmission frequency from the base station (Fd) can happen simultaneously with uplink transmission from remote terminals towards the base station (using Fu). At the same time remote terminals in the inward sectors can transmit uplink towards the repeater using the uplink frequency from the base station (Fu).

By allowing multiple communications between repeaters and remote terminals, the capacity of the network increases. However, the capacity bottleneck is now shifted to the communication between the base station and the time-multiplexed repeaters.

Space Division Multiplexing at the Base Station

A further aspect of the invention eliminates the communication bottleneck between the base station and the time-multiplexed repeaters, which emerges in the case that multiple communications are allowed. This is achieved by allowing several repeaters to communicate simultaneously with the base station. In general, these multiple communications will interfere with each other. Therefore, in one embodiment, the base station can discriminate between the several simultaneous communications. Because the time-multiplexed repeaters (3) are clearly separated in space (see FIG. 3), they can be discriminated by means of space division multiplexing (SDM) or space division multiple access (SDMA) techniques.

Different SDM or SDMA techniques can be applied in different embodiments of this invention, see reference [4]. In a first embodiment, the base station is equipped with sectored antennas. Each antenna has a particular antenna beam pointing in a certain direction. The signals coming from the different directions can be processed at the same time, allowing for simultaneous communications between the base station and the time-multiplexed repeaters.

In another implementation, the base station can form several antenna beams, whose direction can be steered, e.g., electronically. This is called beamforming. Again, the signals coming from the several antenna beams can be processed together. A possible implementation for a beamformer is to have an array of fixed antennas whose signals are combined electronically. Based on the coefficients of the combination algorithm different antenna beam patterns can be generated.

If the transmissions between the time-multiplexed repeaters and the base station experience a large amount of multi-path reflections, the previous approaches, which combined several signals from different antenna's, may not work. In such a case, space-time-processing techniques may be applied. These techniques extend the combination algorithm into the time dimension by using several time samples from each antenna into the combination algorithm.

The base station assigns the time-multiplexed repeaters that can communicate with it in the same time period, e.g., time slot. It broadcasts this information in the TDM schedule. To get optimal performance, the TDM schedule should be determined by an intelligent scheduling algorithm that selects the time-multiplexed repeaters with minimum mutual interference to communicate together.

SDM/SDMA or in general multi-antenna techniques (MAT) can be used to increase the capacity in a standard size cell or to increase the size of a cell. These techniques require multiple antennas to be installed at the base station or at the repeater. By beamforming the radiated power can be concentrated so that effectively a steerable high-directional antenna is formed. In multipath environments alternative space-time processing techniques such as Spatial Division Multiple Access (SDMA) can be used.

Another aspect of the present invention is the combination of MAT techniques that increase the capacity of the network, with repeaters.

In one embodiment, repeaters are used to increase the size of the cell. Repeaters are typically installed significantly higher (10-20 meters) than remote terminals (2-5 meters). Therefore, the path loss between the base station and the repeater is lower than between the base station and the remote terminal. This allows the repeaters to be installed at greater distances from the base station than remote terminals. The remote terminals communicate with a repeater exactly as they would with a base station. The use of SDM/SDMA/MAT allows for the base station to communicate simultaneously with several repeaters and with remote terminals closer to the base station, thereby increasing the transmission capacity of the larger cell.

In another embodiment also repeaters are equipped with MAT. As both the transmitting and receiving sides of the wireless link can benefit of the antenna techniques, several benefits can be gained:
the repeaters can be installed at even greater distances from the base station, thereby expanding the coverage area of the cell.
the repeaters are able to use more efficient modulation schemes for communication with the base station, thereby increasing the transmission capacity of the cell.
the repeaters can use more efficient modulation schemes for communication with remote terminals. This can also benefit the transmission capacity of the cell.

This combined use of repeaters and antenna techniques allows for an extremely modular deployment strategy in the field. An operator can start a deployment with repeaters to achieve quick coverage using large size cells. When the customer penetration increases, MAT technologies are installed to increase the transmission capacity in the cell as required.

The combination of MAT and repeaters provides also opportunities to improve the scheduling of the packets for transmission. In an initial simple approach, it can be considered that the MAT techniques create additional channels. Each channel can be considered independently, remote terminals and repeaters are assigned to it and the scheduling takes place as described above. The scheduling can, however, be optimized further. The scheduler can consider all DL data and UL data transmission requests. The remote terminals/repeaters are not aware over which MAT (Multi-Antenna Technique) channel they are communicating. Therefore, the scheduling algorithm can distribute the data over the different MAT channels so that a more or less equal loading on each channel is obtained. During the scheduling operation, the scheduling algorithm has to check that data packets on different channels are not sent simultaneously to remote terminals that are too close together. To achieve that, the base station may, for instance, keep a table that indicates to which remote terminals information can be sent simultaneously over different MAT channels.

Redundancy and Self-Repairable Network

Another aspect of the present invention is related to the robustness of the network and the immunity against technical failure or against perturbations of the transmission path. Consider FIG. 3. Although the base station is equipped with redundant hardware and software, in one embodiment, each remote terminal is communicating with only one repeater, over only one transmission path. Similarly, in one embodiment, each repeater has only one transmission path towards the base station. Hence, major parts of the network have no backup in case of technical failure or obstruction of a radio transmission path.

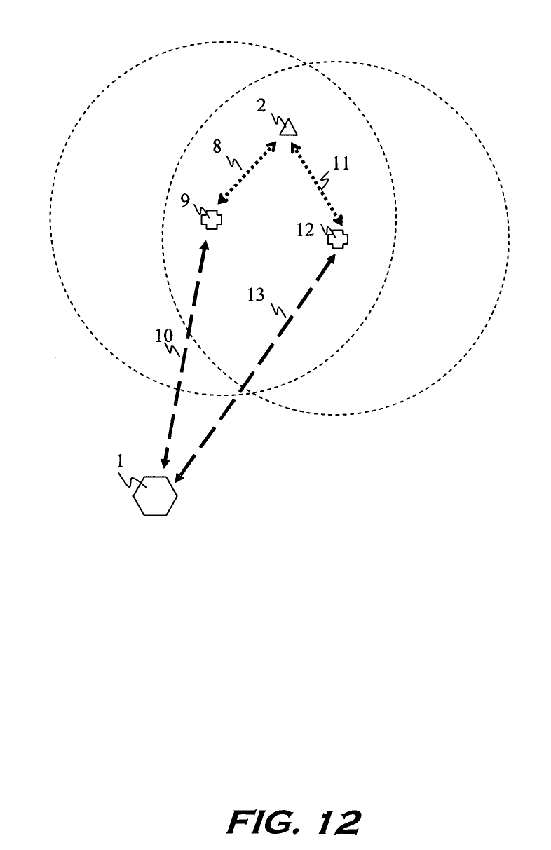

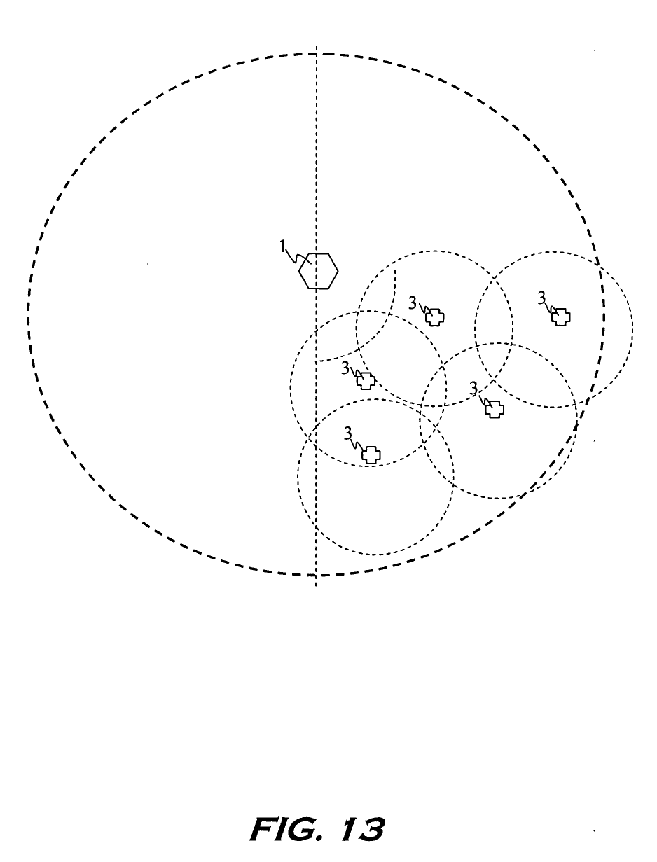

As a solution to this problem, the population density of the time-multiplexed repeaters can be increased to a level where the remote terminals can communicate with more than one repeater. This is depicted in FIG. 12. A backup is available for those repeaters and transmission paths. For instance, in FIG. 12, connection (8), repeater (9) and connection (10) are backups for respectively connection (11), repeater (12) and connection (13).

In a particular embodiment of this aspect of the invention, the backup time-multiplexed repeaters and communications are established upfront and stored both at the remote terminals and at the base station. When the connection is lost between the remote terminal and the base station, the base station notifies at least one backup time-multiplexed repeater to take over the connection. The remote terminal will also decide to switch to its backup connection (either because it lost contact to the first time-multiplexed repeater or because the initial time-multiplexed receiver can no longer reach the base station). By this procedure the connection is maintained without the need for reinitialization.

Simultaneous Re-Transmission by Multiple Repeaters

In the network depicted in FIG. 12, the number of repeaters is greater than strictly necessary. As a consequence, a remote terminal sees multiple time-multiplexed repeaters. The coverage of the base station can be increased using this property.

As explained before, information from a remote terminal is first transmitted to a repeater. However, in the situation depicted in FIG. 12, this information can be transmitted towards more than one repeater. In general, this will be done sequentially. The remote terminals, however, can be equipped with the possibility to send their signals to several time-multiplexed repeaters simultaneously. Let us denote the number of repeaters involved as ‘n’. In a second step, these n repeaters could re-transmit this information simultaneously to the base station. Hence, the base station will receive a multipath signal, originating from n repeaters, with a combined signal power that is n times larger than the average signal power originating from one single repeater. As a result, a larger distance can be covered during the second hop.

Similarly, the base station can transmit information to n repeaters (simultaneously if the base station has SDM capabilities). During the second hop, these n repeaters could re-transmit this information simultaneously towards a remote terminal. This will result in a multipath signal with an n-times larger signal power.

This aspect of the invention can be further optimized: If the n simultaneous radio transmissions are phase-synchronized in such a way that the n radio signals are arriving in-phase at the receiving antenna, the combined power of these radio signals is n² times larger than the average signal power originating from one single radio communication.

Applications

A cellular network applying some or all of the aspects of the invention, as described above, is particularly useful for mass-market applications, e.g., for data communications services, for internet access services, for telephony services or for video services.

When the repeaters and/or remote terminals are mounted at a relatively low height, the radio connections tend to be Non-Line-of-Sight connections. Hence, one embodiment of the invention is particularly suited for radio communications exploiting radio signal modulation techniques that are optimized for Non-Line-of-Sight communications. “Orthogonal Frequency Division Modulation” or “Single-Carrier Modulation with Cyclic Prefix” are examples of modulation techniques optimized for Non-Line-of-Sight radio communications, however, the present invention is not limited to these.

The geographical region covered by a base station can be divided in sectors, as depicted in FIG. 13. All aspects of the invention can be applied to one or more of the sectors of such a base station.

While the above description has pointed out novel features of the invention as applied to various embodiments, the skilled person will understand that various omissions, substitutions, and changes in the form and details of the device of the device or process illustrated may be made without departing from the scope of the invention. Therefore, the scope of the invention is defined by the appended claims rather than by the foregoing description. All variations coming within the meaning and range of equivalency of the claims are embraced within their scope.

### REFERENCES

[1] “Broadband Wireless Network Overcomes Line-Of-Sight (LOS) Constraints and lowers Deployment Cost”, White Paper on UC Wireless website, Aug. 24, 2000,
[2] IEEE Contribution: IEEE 802.16.3c-01/29r4, “Channel Models for Fixed Wireless Applications”
[3] Draft “Medium Access Control Modifications and Additional Physical Layer Specifications for 2-11 GHz”, IEEE 802.16a/D5,
[4] “Space Division Multiple Access for Wireless Local Area Networks”, Patrick Vandenameele, Liesbet Van Der Perre, Marc Engels, Kluwer Academic Publishers, Boston, ISBN 0-7923-7461-4, July 2001.
[5] ETSI EN 301 958 V1.1.1 (2002-03), Digital Video Broadcasting (DVB); Interaction channel for Digital Terrestrial Television (RCT) incorporating Multiple Access OFDM

1. A system for cellular wireless communication, comprising:
a repeater having one or more directional antennas, wherein the system is adapted for:
signal communication between one directional antenna of the repeater with a base station; and
signal communication between the same one directional antenna of the repeater with at least one remote terminal.

2. A system for wireless communication according to claim 1, wherein the one or more directional antennas have an azimuth of about 3 dB beamwidth less than or equal to 120 degrees.

3. A system for wireless communication according to claim 1, wherein the one or more directional antennas have an azimuth of about 3 dB beamwidth less than or equal to 90 degrees.

4. A system according to claim 1, wherein the repeater comprises at least a first and a second radio, and wherein the first radio transmits signals via at least one of the directional antennas and the second radio transmits signals via another one of the directional antennas.

5. A system for wireless communication between a transmitter and a receiver, the system comprising:
a base station having at least one transmitter and at least one receiver;
at least one repeater having at least one transmitter and at least one receiver; and
at least two remote terminals each having a transmitter, a receiver and antenna, with a front-to-back directivity;
wherein the system is adapted to obtain information as to whether the antenna of each of the remote terminals is oriented towards or away from the base station, and wherein the system is further adapted for simultaneous signal transmissions by selecting transmitters and receivers dependent upon the orientations of the antennas of the at least two remote terminals so as to control co-channel interference between the simultaneous communications.

6. A system for wireless communication according to claim 5, wherein the system is further adapted for:
signal transmissions between the base station and a first remote terminal having its antenna oriented towards the base station; and
signal transmissions between the at least one repeater and a second remote terminal having its antenna oriented away from the base station.

7. A system for wireless communication according to claim 5, wherein the system is further adapted for:
signal transmissions between the base station and a first repeater; and
signal transmissions between a second repeater and a remote terminal having its antenna oriented away from the base station.

8. A system for wireless communication according to claim 5, wherein the system is further adapted for:
signal transmissions between the at least one repeater and a first remote terminal having its antenna oriented away from the base station; and
signal transmissions between the at least one repeater and a second remote terminal having its antenna oriented towards the base station.

9. A system for wireless communication according to claim 5, wherein the system is further adapted for:
signal transmissions between the at least one repeater and the base station; and
signal transmissions between the at least one repeater and a remote terminal having its antenna oriented towards the base station.

10. A system for wireless communication according to claim 5, wherein the system is further adapted for:
signal transmissions between the base station and a first remote terminal having its antenna oriented towards the base station; and
signal transmissions between the at least one repeater and a remote terminal having its antenna oriented towards the base station.

11. A system for wireless communication according to claim 5, wherein a frequency division duplexing (FDD) is used for duplex transmission from and towards the base station.

12. A system for wireless communication according to claim 11, wherein a transmission from the at least one repeater in a direction away from the base station is done using the same frequency that is used for a transmission from the at least one repeater towards the base station.

13. A system for wireless communication according to claim 11, wherein a transmission from a remote terminal towards the at least one repeater in a direction towards the base station is done using the same frequency that is used for a transmission by the base station to a repeater or a remote terminal.

14. A system for wireless communication according to claim 5, wherein a time division duplexing (TDD) is used for duplex transmission from and towards the base station.

15. A system for wireless communication according to claim 5, further comprising means for scheduling the transmission from the base station of data packets in frames to repeaters and for ordering the sequence of transmitting data packets within a frame according to a decreasing amount of time that is required by the repeaters to transmit data packets of the frame towards remote terminals in a direction towards the base station.

16. A system for wireless communication according to claim 15, wherein the transmission from the base station of data packets towards a repeater is delayed during the time period in which the repeater is scheduled to transmit to remote terminals in a direction towards the base station.

17. A system for wireless communication according to claim 15, further comprising means for consulting a database storing selected ones of communication paths between any two of remote terminals, base stations and repeaters and means for deciding whether simultaneous transmission by different repeaters is to be enabled based on data retrieved from the database.

18. A system for wireless communication according to claim 15, wherein the transmission of at least one uplink data packet towards a repeater from at least one remote terminal whose antenna is oriented in a direction away from the base station, is scheduled before an uplink transmission from the repeater towards the base station.

19. A system for wireless communication according to claim 5, further comprising means for using multiple antennas to set up parallel simultaneous communications at the same frequency between the base station and a plurality of repeaters or remote terminals

20. A system according to claim 19, further comprising means for scheduling the transmission of data packets from the base station to repeaters or remote terminals wherein data packets for the same repeater or remote terminal can be transmitted alternatingly on the plurality of parallel simultaneous communications provided by the multiple antennas.

21. A system for wireless communication according to claim 5, wherein a remote terminal can communicate with a second repeater in case of loss of communication with a first repeater without need for reinitialization.

22. A method of cellular wireless communication for a repeater having one or more directional antennas, the method comprising:
communicating signals between one directional antenna of the repeater and a base station; and
communicating signals between the same one directional antenna of the repeater and at least one remote terminal.

23. A method of wireless communication in a network comprising a base station, a repeater and at least two remote terminals each having an antenna, a transmitter and a receiver, the method comprising:
obtaining information as to whether the antenna of each of the remote terminals is oriented towards or away from the base station; and
simultaneously transmitting signals by selecting transmitters and receivers dependent upon the orientations of the antennas of the at least two remote terminals so as to control co-channel interference between the simultaneous communications.

24. A method according to claim 23, wherein the simultaneously transmitting comprises:
transmitting signals between the base station and a first remote terminal having its antenna oriented towards the base station; and
transmitting signals between the at least one repeater and a second remote terminal having its antenna oriented away from the base station.

25. A method according to claim 24, wherein the simultaneously transmitting comprises:
transmitting signals between the base station and a first repeater; and
transmitting signals between a second repeater and a remote terminal having its antenna oriented away from the base station.

26. A method according to claim 24, wherein the simultaneously transmitting comprises:
transmitting signals between the at least one repeater and a first remote terminal having its antenna oriented away from the base station; and
transmitting signals between the at least one repeater and a second remote terminal having its antenna oriented towards the base station.

27. A method according to claim 23, wherein the simultaneously transmitting comprises:
transmitting signals between the at least one repeater and the base station; and
transmitting signals between the at least one repeater and a remote terminal having its antenna oriented towards the base station.

28. A method according to claim 23, wherein the simultaneously transmitting comprises:
transmitting signals between the base station and a first remote terminal having its antenna oriented towards the base station; and
transmitting signals between the at least one repeater and a remote terminal having its antenna oriented towards the base station.

29. A method according to claim 23, wherein a frequency division duplexing (FDD) is used for duplex transmission from and towards the base station.

30. A method according to claim 29, wherein a transmission from the at least one repeater in a direction away from the base station is done using the same frequency that is used for a transmission from the at least one repeater towards the base station.

31. A method according to claim 30, wherein a transmission from a remote terminal towards the at least one repeater in a direction towards the base station is done using the same frequency that is used for a transmission by the base station to a repeater or a remote terminal.

32. A method according to claim 23, wherein a time division duplexing (TDD) is used for duplex transmission from and towards the base station.

33. A method according to claim 23, further comprising scheduling the transmission from the base station of data packets in frames to repeaters and ordering the sequence of transmitting data packets within a frame according to a decreasing amount of time that is required by the repeaters to transmit data packets of the frame towards remote terminals in a direction towards the base station.

34. A method according to claim 33, wherein the transmission from the base station of data packets towards a repeater is delayed during the time period in which the repeater is scheduled to transmit to remote terminals in a direction towards the base station.

35. A method according to claim 33, wherein the transmission of at least one uplink data packet towards a repeater from at least one remote terminal whose antenna is oriented in a direction away from the base station, is scheduled before an uplink transmission from the repeater towards the base station.

36. The method of claim 5, wherein the front-to-back directivity of each remote terminal antenna is at least 15 dB.

37. The method of claim 23, wherein each remote terminal antenna has a front-to-back directivity of at least 15 dB.

38. The method of claim 23, wherein the network comprises one of the following:
CDMA, FDMA, TDMA, a combination of CDMA, FDMA and TDMA, a combination of FDMA and TDMA, and a combination of CDMA and FDMA.

39. A system for cellular wireless communication, comprising:
a repeater having one or more directional antennas, wherein one directional antenna of the repeater is adapted to communicate signals with a base station, and wherein the same one directional antenna of the repeater is adapted to communicate signals with at least one remote terminal.

40. The system of claim 39, wherein the one or more directional antennas have an azimuth of about 3 dB beamwidth less than or equal to 120 degrees or 90 degrees.

41. A system for cellular wireless communication, comprising:
at least one repeater having at least one transmitter and at least one receiver, wherein the at least one repeater is adapted to substantially simultaneously communicate signals with each of a plurality of remote terminals using the same frequency.

42. The system of claim 41, wherein the at least one repeater is further adapted to communicate signals with a first remote terminal having its antenna oriented away from a base station, and to communicate signals with a second remote terminal having its antenna oriented towards the base station.

43. The system of claim 41, wherein the at least one repeater is further adapted to communicate signal with a base station, and to communicate signals with a remote terminal having its antenna oriented towards the base station.

44. The system of claim 41, wherein the at least one repeater comprises at least one adjustable selective antenna that can be electronically or mechanically pointed towards the different remote terminals.

45. A system for cellular wireless communication, comprising:
means for communicating signals between one directional antenna of the repeater and a base station; and
means for communicating signals between the same one directional antenna of the repeater and at least one remote terminal.

46. The system of claim 1, wherein the system is associated with a cellular wireless network used with terrestrial mobile transceivers.

47. The system of claim 5, wherein the system is associated with a cellular wireless network used with terrestrial mobile transceivers.

48. The method of claim 22, wherein the method is associated with a cellular wireless network used with terrestrial mobile transceivers.

49. The method of claim 23, wherein the method is associated with a cellular wireless network used with terrestrial mobile transceivers.

50. The system of claim 39, wherein the system is associated with a cellular wireless network used with terrestrial mobile transceivers.

51. The system of claim 41, wherein the system is associated with a cellular wireless network used with terrestrial mobile transceivers.

52. The system of claim 45, wherein the system is associated with a cellular wireless network used with terrestrial mobile transceivers.
